(19) United States
(12) Patent Application Publication
(10) Pub. No.: US 2012/0065744 A1
(43) Pub. Date: Mar. 15, 2012

(54) MODEL BASED CONTROL OF SHAPE MEMORY ALLOY DEVICE

(75) Inventors: Ravindra Brammajyosula, Guntur (IN); Vidyashankar R. Buravalla, Bangalore (IN); Ashish Khandelwal, Bangalore (IN)

(73) Assignee: GM GLOBAL TECHNOLOGY OPERATIONS, INC., Detroit, MI (US)

(21) Appl. No.: 12/878,265

(22) Filed: Sep. 9, 2010

(51) Int. Cl. G05B 13/02; G06G 7/48; G06F 17/10

(52) U.S. Cl. 700/29; 703/2; 703/6

(57) ABSTRACT

A method of modeling a Shape Memory Alloy (SMA) element to predict a response of the SMA element includes obtaining the resistivity of the SMA element over a range of a physical property of the SMA element; correlating variations in the obtained resistivity with respect to the physical property of the SMA element to identify behavioral differences in the resistivity for the different phases of the SMA element; calculating a rate of change of the resistivity of the SMA element over a period of time; calculating the derivative of the rate of change in the resistivity of the SMA element over the period of time; and comparing real time data of the physical property to the derivative of the rate of change to predict the response of the shape memory alloy element.

### TECHNICAL FIELD

The invention generally relates to a method of controlling a device having a shape memory alloy element, and also to a method of modeling the shape memory alloy element to predict a response of the shape memory alloy element.

### BACKGROUND

Many different devices use shape memory alloy elements as actuators. These devices may include, but are not limited to, seat belt presenters, pressure relief valves or air vents. The shape memory alloy element may change phases between an austenite phase, a martensite phase and an R-phase. The shape memory alloy element includes different material characteristics in each of these phases, and therefore responds differently to a change in conditions, e.g., a change in temperature, load, stress, strain, when in each of these different phases.

The state of the shape memory alloy element for any given situation and/or condition must be known or in some manner predicted in order to properly predict the response of the shape memory alloy element to a change in conditions. The response of the shape memory alloy element to a change in conditions must be known or in some manner predicted in order to properly control the device. Accordingly, sensing and/or estimating the state and/or phase of the shape memory alloy element is essential to the monitoring and control of the shape memory alloy element.

### SUMMARY

A method of controlling a device including a shape memory alloy element is provided. The method includes sensing real time data related to a physical property of the shape memory alloy element. The method further includes comparing the sensed real time data to a model based upon a hysteretic response of the shape memory alloy element as a function of the physical property of the shape memory alloy element to predict a response of the shape memory alloy element. The method further includes utilizing the predicted response of the shape memory alloy element from the model to control the device.

A method of modeling a response of a shape memory alloy element is also provided. The method includes obtaining the resistivity of the shape memory alloy element over a range of a physical property of the shape memory alloy element. The method further includes correlating variations in the obtained resistivity in the shape memory alloy element with respect to the physical property of the shape memory alloy element to identify behavioral differences in the resistivity of the shape memory alloy element during thermal cycling of the shape memory alloy element between an austenite phase, a martensite phase and a R-phase. The method further includes continuously sensing real time data related to the physical property over a period time. The method further includes comparing the sensed real time data of the physical property of the shape memory alloy element to the correlated variations in the resistivity of the shape memory alloy element to predict the response of the shape memory alloy element.

Accordingly, the method of modeling the shape memory alloy element provides an accurate prediction of the response of the shape memory alloy element to a change in conditions. This highly accurate prediction of the response of the shape memory alloy element allows for better sensing and control of the shape memory alloy element, which improves the operation of the device.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic control scheme diagram of a device including a shape memory alloy element.

### DETAILED DESCRIPTION

A method of controlling a device is provided. The device includes a shape memory alloy element. The device may include any type and/or manner of device that utilizes the shape memory alloy element. For example, the device may include, but is not limited to, an air vent assembly, a pressure relief valve, a seat belt presenter, a circuit breaker, a sensor, or some other similar device. The shape memory alloy element may be employed as an active actuator to induce movement in the device under certain conditions, as a passive actuator to induce a force or a displacement passively, such as in a super-elastic stent or denture wire, or as a sensor to determine operating conditions of the device. Additionally, the shape memory alloy element may be used both as a sensor and as an actuator. It should be appreciated that the shape memory alloy element may be used in some other manner not shown or described herein.

Suitable shape memory alloys can exhibit a one-way shape memory effect, an intrinsic two-way effect, or an extrinsic two-way shape memory effect depending on the alloy composition and processing history. The two phases that occur in shape memory alloys are often referred to as martensite and austenite phases. The martensite phase is a relatively soft and easily deformable phase of the shape memory alloys, which generally exists at lower temperatures. The austenite phase, the stronger phase of shape memory alloys, occurs at higher temperatures. Shape memory materials formed from shape memory alloy compositions that exhibit one-way shape memory effects do not automatically reform, and depending on the shape memory material design, will likely require an external mechanical force to reform the shape orientation that was previously exhibited. Shape memory materials that exhibit an intrinsic shape memory effect are fabricated from a shape memory alloy composition that will automatically reform themselves.

The shape memory alloy may further include an R-phase. The R-phase is a martensitic phase in nature, but is not the martensite phase described above that is responsible for the shape memory and superelastic effect. The R-phase competes with martensite, often completely absent, and often appearing during cooling before martensite then giving way to martensite upon further cooling. Similarly, the R-phase may be observed during heating prior to reversion to austenite, or may be completely absent. The R-phase to austenite transformation (A-R) is reversible, with a very small hysteresis (typically 2-5 degrees C.). It also exhibits a very small shape memory effect, and within a very narrow temperature range. The R-phase may be stress-induced as well as thermally-induced. The stress rate is less than the stress rate compared to the austenite-martensite transformation. The shape memory alloy undergoes martensite to austenite transformation during the heating cycle, and undergoes austenite to martensite transformation during the cooling cycle. When stress levels of the shape memory alloy are under 200 Mpa, the shape memory alloy also transforms into the intermediate R-phase during the cooling cycle. The transformation strain associated with the R-phase is small, i.e., up to 1%, but has higher resistivity compared to the martensite phase and the austenite phase.

The temperature at which the shape memory alloy remembers its high temperature form when heated can be adjusted by slight changes in the composition of the alloy and through heat treatment. In nickel-titanium shape memory alloys, for example, it can be changed from above about 100° C. to below about −100° C. The shape recovery process occurs over a range of just a few degrees and the start or finish of the transformation can be controlled to within a degree or two depending on the desired application and alloy composition. The mechanical properties of the shape memory alloy vary greatly over the temperature range spanning their transformation, typically providing the shape memory material with shape memory effects as well as high damping capacity. The inherent high damping capacity of the shape memory alloys can be used to further increase the energy absorbing properties.

Suitable shape memory alloy materials include without limitation nickel-titanium based alloys, indium-titanium based alloys, nickel-aluminum based alloys, nickel-gallium based alloys, copper based alloys (e.g., copper-zinc alloys, copper-aluminum alloys, copper-gold, and copper-tin alloys), gold-cadmium based alloys, silver-cadmium based alloys, indium-cadmium based alloys, manganese-copper based alloys, iron-platinum based alloys, iron-platinum based alloys, iron-palladium based alloys, and the like. The alloys can be binary, ternary, or any higher order so long as the alloy composition exhibits a shape memory effect, e.g., change in shape orientation, damping capacity, and the like. For example, a nickel-titanium based alloy is commercially available under the trademark NITINOL from Shape Memory Applications, Inc.

The shape memory alloy may be activated by any suitable means, preferably a means for subjecting the material to a temperature change above, or below, a transition temperature. For example, for elevated temperatures, heat may be supplied using hot gas (e.g., air), steam, hot liquid, or electrical current. The activation means may, for example, be in the form of heat conduction from a heated element in contact with the shape memory material, heat convection from a heated conduit in proximity to the thermally active shape memory material, a hot air blower or jet, microwave interaction, resistive heating, and the like. In the case of a temperature drop, heat may be extracted by using cold gas, or evaporation of a refrigerant. The activation means may, for example, be in the form of a cool room or enclosure, a cooling probe having a cooled tip, a control signal to a thermoelectric unit, a cold air blower or jet, or means for introducing a refrigerant (such as liquid nitrogen) to at least the vicinity of the shape memory material.

The method includes generating a model to predict the response of the shape memory alloy element to a change in conditions. The model is based on the physics of the shape memory alloy element, and models the hysteretic response of the shape memory alloy element as a function of a physical property of the shape memory alloy element. More specifically, the model is based upon the hysteretic response of the resistivity of the shape memory alloy element as a function of the physical property. The physical property of the shape memory alloy element may include, but is not limited to, a temperature of the shape memory alloy element, a stress of the shape memory alloy element or a strain of the shape memory alloy element.

The electrical resistance of the shape memory alloy element plays a central role in the joule heating of the shape memory alloy element, and is a good predictor for sensing the state of transformation, start of actuation or abnormal event detection of the shape memory alloy element. Because the model is based on the physics behind the shape memory alloy element, the model provides better flexibility and fidelity in capturing the response of the shape memory alloy element than prior input-output models. The model may be used in several ways to achieve the sensing and/or control of the shape memory alloy element, including but not limited to, using the model to limit errors in real-time data or using the model extensively, with only minimal real-time data input, to control the shape memory alloy element.

Generating the model includes obtaining, i.e., capturing, the resistivity of the shape memory alloy element over a range of the physical property of the shape memory alloy element. The resistivity of the shape memory alloy element shows a specific hysteretic response as a function of temperature, stress or strain. The hysteretic response occurs over a given transformation cycle, i.e., over both a forward and reverse transformation, however, the change in resistivity during the forward transformation may not be identical to the change in resistivity during the reverse transformation.

Obtaining the resistivity of the shape memory alloy element may further be defined as calculating the resistivity of the shape memory alloy element through a Lumped Parameter Model (LPM) for thermo-mechanical response of the shape memory alloy during the phase transformation. However, it should be appreciated that the resistivity of the shape memory alloy element may be obtained through other methods not described herein.

Obtaining the resistivity of the shape memory alloy element may include obtaining a change in the resistivity of the shape memory alloy element over the range of the physical property. In other words, the model captures the change in the resistivity of the shape memory alloy element relative to changes of the physical property of the shape memory alloy element.

Generating the model may further include quantifying the obtained change in resistivity of the shape memory alloy element. The resistivity is quantified to assess the state of the shape memory alloy element. For example, because the resistance for the austenite phase, the R-phase and the martensite phase are known, the resistance changes during the transformation may be computed. It should be appreciated that during phase transformation, the shape memory alloy element may be a mixture of all three phases. The change in resistivity may be quantified in any suitable manner. For example. The change in resistivity may be quantified with a martensitic volume fraction that evolves during transformation of the shape memory alloy element between the austenite phase, the martensite phase, and the R-phase.

Generating the model may further include correlating variations in the obtained resistivity in the shape memory alloy element with respect to the physical property of the shape memory alloy element to identify behavioral differences in the resistivity of the shape memory alloy element during thermal cycling of the shape memory alloy element. For example, the R-phase may be present or absent, depending on the stress level and also the nature of the shape memory alloy. The nature of the hysteretic response will be different, depending on the presence or absence of the R-phase. Also, because transformation occurs over only a given temperature or stress range, it is possible to identify whether the transformation has started or ended, etc., by looking at the resistance/resistivity response as a function of the physical parameter. Moreover, resistance is a function of temperature and hence variations in the ambient temperature can be determined based on the resistance signal and its change. Correlating variations in the obtained resistivity in the shape memory alloy element may further be defined as correlating variations in the obtained resistivity in the shape memory alloy element to identify the austenite phase, the martensite phase and the R-phase of the shape memory alloy element. While it has been difficult in the past to isolate and identify the R-phase of the shape memory alloy element, the electrical resistance of the shape memory alloy element easily identifies and separates the R-phase related responses from other responses of the shape memory alloy element, allowing for better sensing and control of the shape memory alloy element. Because the model accurately captures the electro-thermomechanical response of the shape memory alloy for the R-phase, the model allows the exploitation and/or use of the R-phase in the control of the device. For example, the R-phase based sensing/actuation may be used to design small strain applications such as circuit breakers, the R-phase resistivity monitoring during shake down and training may help optimize the number of cycles and increase useful life of the device, or the R-phase resistively evolution in time may also be used to monitor stress excursions and overload as the R-phase contribution to the shape memory alloy element resistance and its derivative during cooling changes with applied load.

Correlating variations in the obtained resistivity in the shape memory alloy element may include calculating a rate of change of the resistivity of the shape memory alloy element over a period of time. Calculating the rate of change of the resistivity of the shape memory alloy element over a period of time may include iteratively calculating the resistance of the shape memory alloy element over the period of time. This is achieved by differentiating the resistance input (measured or estimated from the model) with respect to time. This may include taking the difference of resistance over a known time interval and dividing the change in resistance by that time interval. Because of the derivative nature of the signal, the time rate of change in resistivity can be a better signal/source to identify important stages in transformation like onset, mid-stage and end of transformation. For instance, even if the resistance signal is monotonic (either increasing or decreasing continuously), the rate of increase or decrease could be time dependent, with a faster or slower rate of increase or decrease. These features are clearly reflected in the derivative signal. The derivate may be extracted in several ways. The derivative need not be the first derivate described above. For more sensitive data analysis and information extraction, higher order derivatives may be obtained from either the real-time data, the model or both.

Generating the model further includes calculating a derivative of the rate of change in the resistance of the shape memory alloy element over the period of time to identify key events of the shape memory alloy element. The key events of the shape memory alloy element occur during transformation of the shape memory alloy element between the austenite phase, the martensite phase and the R-phase of the shape memory alloy element. The method may further include comparing the derivative of the resistance of the shape memory alloy element obtained from the sensed real time data to the prediction of the resistance obtained from the model to predict which of the austenite phase, the martensite phase and the R-phase the shape memory alloy element is in.

Generating the model may further include factoring in variations in the resistivity with respect to the physical property. For example, the base line resistivities of the individual phases vary with temperature and stress, more so with stress. Normal measurements of resistance (under realistic device conditions) are not reliable to extract this information. Having a model for resistivity/resistance helps in overcoming this drawback. Furthermore, generating the model may further include factoring in variations in the resistivity of the shape memory alloy element with respect to at least one variable. The variable may include, but is not limited to, an ambient air temperature, a heat transfer coefficient of the shape memory alloy element and a load on the shape memory alloy element.

The method further includes sensing real time data related to the physical property of the shape memory alloy element. Sensing real time data related to the physical property may include continuously sensing real time data related to the physical property over the period of time.

The method may include comparing the sensed real time data to the model to predict a response of the shape memory alloy element. The model predicts the resistance/resistivity/strain or stress based on the material properties built into the model and the device specific data like length of the shape memory alloy device, etc. Then, using the real time data, an “error” signal may be generated based on the difference between the model and the real time data. This error signal may be used to (1) correct the model for ambient uncertainties, or (2) may be used to generate appropriate feedback signals to adjust the shape memory alloy device response by altering the current for actuation, etc.

The method may further include utilizing the predicted response of the shape memory alloy element from the model to control the device. Utilizing the predicted response of the shape memory alloy element from the model to control the device may include utilizing the predicted response from the model to predict which of the austenite phase, the martensite phase and the R-phase the shape memory alloy element is in. Alternatively, utilizing the predicted response of the shape memory alloy element from the model to control the device includes adjusting a component of the device based upon the predicted response of the shape memory alloy element.

Additionally, the health of the shape memory alloy element may be checked by referencing the resistance/resistivity data contained within the model. Accordingly, even while the device is inactive, the state of the shape memory alloy element may be estimated off-line.

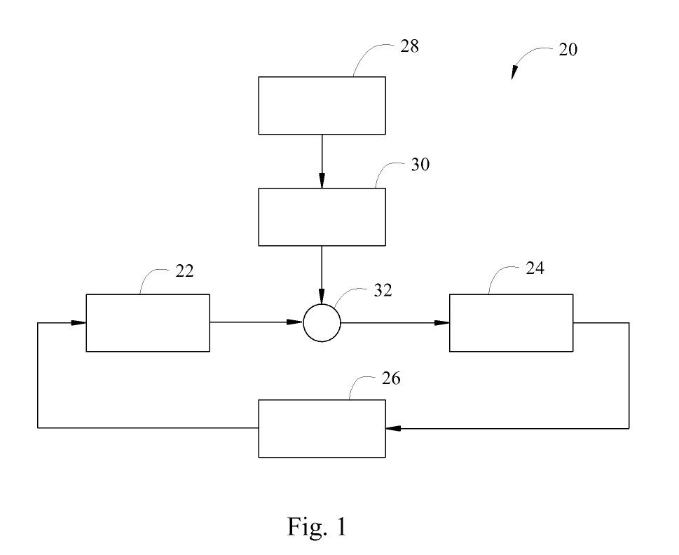

Referring to FIG. 1, an example of a schematic control scheme for a device is shown generally 20. The control scheme employs the model and the method described above. The device includes a controller 22, and a shape memory alloy element 24. The current resistance of the shape memory alloy element is measured and supplied to the controller at block 26. Real time data related to the ambient temperature adjacent the device is continuously sensed at block 28. The real time data is supplied to the model, which uses the sensed real time data related to the ambient temperature to predict the phase and/or the response of the shape memory alloy element at block 30. Based upon the current measured resistance/resistivity of the shape memory alloy element, and the predicted response of the shape memory alloy element, the controller may alter the power supplied to the shape memory alloy element to achieve a desired function of the device at block 32.

While the best modes for carrying out the invention have been described in detail, those familiar with the art to which this invention relates will recognize various alternative designs and embodiments for practicing the invention within the scope of the appended claims.

1. A method of controlling a device including a shape memory alloy element, the method comprising:
sensing real time data related to a physical property of the shape memory alloy element;
comparing the sensed real time data to a model based upon a hysteretic response of the shape memory alloy element as a function of the physical property of the shape memory alloy element to predict a response of the shape memory alloy element; and
utilizing the predicted response of the shape memory alloy element from the model to control the device.

2. A method as set forth in claim 1 further comprising generating the model based upon the hysteretic response of the shape memory alloy element as a function of the physical property.

3. A method as set forth in claim 2 wherein generating the model includes obtaining a resistivity of the shape memory alloy element over a range of the physical property of the shape memory alloy element.

4. A method as set forth in claim 3 wherein obtaining a resistivity of the shape memory alloy element is further defined as calculating the resistivity of the shape memory alloy element through a Lumped Parameter Model for thermo-mechanical response of the shape memory alloy.

5. A method as set forth in claim 3 wherein generating the model further includes correlating variations in the obtained resistivity in the shape memory alloy element with respect to the physical property of the shape memory alloy element to identify behavioral differences in the resistivity of the shape memory alloy element during thermal cycling of the shape memory alloy element.

6. A method as set forth in claim 5 wherein correlating variations in the obtained resistivity in the shape memory alloy element is further defined as correlating variations in the obtained resistivity in the shape memory alloy element to identify an austenite phase, a martensite phase and a R-phase of the shape memory alloy element.

7. A method as set forth in claim 6 wherein sensing real time data related to the physical property is further defined as continuously sensing real time data related to the physical property over a period time.

8. A method as set forth in claim 7 wherein generating the model further includes capturing a change in resistivity of the shape memory alloy element.

9. A method as set forth in claim 8 wherein generating the model further includes quantifying the captured change in resistivity of the shape memory alloy element with a martensitic volume fraction that evolves during transformation of the shape memory alloy element between the austenite phase, the martensite phase, and the R-phase.

10. A method as set forth in claim 9 wherein correlating variations in the obtained resistivity in the shape memory alloy element includes calculating a rate of change of the resistivity of the shape memory alloy element over a period of time.

11. A method as set forth in claim 10 wherein calculating the rate of change of the resistivity of the shape memory alloy element over a period of time includes iteratively calculating the resistance of the shape memory alloy element over the period of time.

12. A method as set forth in claim 11 wherein generating the model further includes calculating a derivative of the resistance of the shape memory alloy element over the period of time to identify key events of the shape memory alloy element during transformation of the shape memory alloy element between the austenite phase, the martensite phase and the R-phase of the shape memory alloy element.

13. A method as set forth in claim 12 further comprising comparing the derivative of the resistance of the shape memory alloy element obtained from both the sensed real time data and the prediction from the model to predict which of the austenite phase, the martensite phase and the R-phase the shape memory alloy element is in.

14. A method as set forth in claim 13 wherein generating the model further includes factoring in variations in the resistivity with respect to the physical property.

15. A method as set forth in claim 14 wherein generating the model further includes factoring in variations in the resistivity of the shape memory alloy element with respect to at least one variable of a group of variables including an ambient air temperature, a heat transfer coefficient of the shape memory alloy element, and a load on the shape memory alloy element.

16. A method as set forth in claim 15 wherein utilizing the predicted response of the shape memory alloy element from the model to control the device includes adjusting a component of the device based upon the predicted response of the shape memory alloy element.

17. A method as set forth in claim 1 wherein the physical property of the shape memory alloy element includes one of a group of properties including a temperature of the shape memory alloy element, a stress of the shape memory alloy element or a strain of the shape memory alloy element.

18. A method of modeling a response of a shape memory alloy element, the method comprising:
obtaining the resistivity of the shape memory alloy element over a range of a physical property of the shape memory alloy element;
correlating variations in the obtained resistivity in the shape memory alloy element with respect to the physical property of the shape memory alloy element to identify behavioral differences in the resistivity of the shape memory alloy element during thermal cycling of the shape memory alloy element between an austenite phase, a martensite phase and a R-phase;
continuously sensing real time data related to the physical property over a period of time; and
comparing the sensed real time data of the physical property of the shape memory alloy element to the correlated variations in the resistivity of the shape memory alloy element to predict the response of the shape memory alloy element.

19. A method as set forth in claim 18 wherein correlating variations in the obtained resistivity in the shape memory alloy element includes calculating a rate of change of the resistivity of the shape memory alloy element over a period of time.

20. A method as set forth in claim 19 further comprising calculating a derivative of the rate of change in the resistance of the shape memory alloy element over the period of time to identify key events of the shape memory alloy element during transformation of the shape memory alloy element between the austenite phase, the martensite phase and the R-phase of the shape memory alloy element.
